(19) United States
(12) Patent Application Publication
(10) Pub. No.: US 2016/0200048 A1
(43) Pub. Date: Jul. 14, 2016

(54) Networks for Healing Soft Tissues

(71) Applicant: Anuthep Benja-Athon, New York, NY (US)

(72) Inventor: Anuthep Benja-Athon, New York, NY (US)

(21) Appl. No.: 14/591,941

(22) Filed: Jan. 8, 2015

(51) Int. Cl. B29C 67/00; G05B 19/4099

(52) U.S. Cl. CPC B29C 67/0088; G05B 19/4099; B33Y 50/02

(57) ABSTRACT

Networks healing soft tissue disorders by prescribing specific digital frameworks for specific disorders in the networks and instructing machines and 3-D printers to fabricate and render specific real frameworks for physically reinforcing the tissues based on digital data on the prescribed frameworks.

### FIELD OF THE INVENTION

Networks for healing soft tissues

### BACKGROUND OF THE INVENTION

Muscles, tendons, ligaments and connective tissues forming very large and diverse biological frameworks for enabling people and animals to thrive and function. However, aging, injuries, disorders and diseases are perpetual processes which surely and continually weaken, damage and destroy said components of said biological frameworks of all living.

The status quo managements of supra are deficient in basic and clinical sciences. Therefore, billions of people heretofore lacked the system and method provided by the present invention.

The present invention uses networked servers, computers and mobile communication devices to prescribe, render and fabricate diverse specific electronic and real 2-D and 3-D frameworks for reinforcing, supporting and healing said biological components based on scientific and real data being used and processed in networked servers, computers and mobile communication devices having touchscreens.

The present invention heals, rejuvenates, restores and improves the quality and standard of life and lengthens the longevity of billions of people and other living.

### SUMMARY OF THE INVENTION

Networks having a system and method for healing soft tissues disorders. Said system having a plurality of repositories for prescribing electronic digital frameworks based the associations of data on medical histories attached to data on anatomical landmarks in images and videos and data on the functional anatomy and biomechanics in storage means in said networks. Based on individual prescriptions in said networks, said repositories instruct manufacturing machines and 3-D printers how to fabricate and render specific real frameworks for said disordered soft tissues and for functionally and biomechanically related body parts of specific patients.

### DESCRIPTION OF THE PREFERRED EMBODIMENTS

Uniquely, the present invention applies the immense knowledge and data basic and clinical sciences and medicine on the functional anatomy, biomechanics, ergonomic and related disorders and diseases of human uniquely known to and accumulated for 4 decades by this author who is a practicing physical medicine and pain management physician. In addition, modern hardware, software, apps, networking, telecommunication and information technologies are applied to supra to enable all humans—through whom other livings benefit from the present invention—about 7 billions to benefit from the present invention.

Electronically percolating and expanding in and through networks infra, said digital data on disordered soft and hard tissues of body parts relating to their physiology, pathology, gross, microscopic and functional anatomy, biomechanics and ergonomics of individual and functionally and biomechanically related body parts of people are generated and improved through research in a network of servers networked to servers, computers and mobile communication devices including smartphones having touchscreens and manufacturing machines and 3-D printers in USA and other nations. Said servers, computers, devices and machines have repositories comprising storage and processing means.

Billions of people can use computers and mobile devices including billions of smartphones having touch-sensitive aka touchscreens to generate, comment, mark, highlight and edit of images, videos and selfies of their body parts whose anatomical parts and landmarks can be electronically highlighted, marked, tagged and accentuated by common and commercially available such as, but not limited to, fingers, pointers, pens, colors and lights of diverse wavelengths and the like for achieve said means for conveying, communicating, transmitting, storing, sharing and retreiving said data in and among said repositories.

Based on information and data in the aforementioned paragraphs, there are infinite compositions, designs and variations of the real frameworks, structures or lattices for accommodating, fitting, healing and treating and any combinations thereof—achievable, doable and deliverable only by the present invention—for said people and livings.

So, cameras of said computers and mobile devices, smartphones touch-sensitive smartphones are used to take images, videos and selfies of body parts—afflicted part and functionally and biomechanically related parts—whose anatomical landmarks of issue can be electronically highlighted, marked, tagged and accentuated by common and commercially available such as, but not limited to, fingers, pointers, pens, colors and lights to online convey, communicate, transmit, store, share and get said digital data in and among said repositories.

Attached to said transmitted data stored in said repositories and storage means are data of past and current and past medical and surgical histories including, but not limited to, repetitive strain injuries, cumulative trauma disorders, overuse syndromes, chronic pain, acute, subacute and chronic traumas, injuries, degenerative diseases, diverse musculoskeletal, connective tissue, soft tissue, origins and insertions of soft tissues to bones and cartilages and the likes and autoimmune diseases henceforth collectively known as medical history or histories. Further attached, are bodily dimensions and sizes of individuals directly and indirectly related to said submitted data.

Said server repositories have computer programs having attached processing means created by the present invention to prescribe specific electronic frameworks also known as digital frameworks for specific disordered soft tissues of specific body parts—which may be functionally and biomechanically related to other body parts—of specific individuals by associating and analyzing said specific data to prescribe specific electronic frameworks—adaptable and editable to effect the features, properties and characters of the frameworks described in this specification—based on said knowledge and data basic and clinical sciences and medicine stored in said server repositories.

So, in said repositories in said networks, each specific electronic framework stored in said storage means is seen, used and adapted, modified and edited by relating repositories such as, but not limited to, requesting and server repositories in said networks. Therefore, the characters, features and properties of each related real framework to supra is accordingly affected and modified and reproduced.

For example, said server repositories prescribing specific adaptable and editable electronic frameworks and braces and said prescribing repositories instruct networked manufacturing machines and 3-D printers how to fabricate and render specific real frameworks for fixing specific disordered body parts of specific patients. Said machines and printers fabricate and render said specific real frameworks whose fabrications, renderings and constructions are composed of various commercially available materials having diverse physical compositions and properties to manufacture, fabricate, render and print diverse types, configurations, designs, dimensions and strengths of specific frameworks or lattices. One of said preferred embodiments uses, but not limited to, common commercial and hypoallergenic tapes, fabrics and wires for physically reinforcing and supporting disordered soft tissues of body parts of patients. The tapes, fabrics and wires are flexible, extendable and rigid tapes, fabrics and wires having adhesive, nonadhesive, strand, thread and energy means for gluing, stitching, attaching and anchoring said tapes, fabrics, wires and body parts. Said components composed of all possible physical compositions, configurations such as, but not limited to, long and short strips, round and triangular patches, and appearances and designs such as, but not limited to, colors, visual stimuli and identifications and labels for enabling the optimal applications and effectiveness on said patients.

Very often, a disordered body part of an individual is functionally and biomechanically related to ipsilateral and contralateral proximal and distal body parts. In other words, in certain circumstances, a disordered body part may and can be caused by or related to the functions and biomechanics of related parts. So, said first digital data can and will also include similar first data on functionally and biomechanically related body parts in images and videos of specific patients and are similarly processed by said requesting repositories and server repositories based on data association in the storage means as described in the specification. Consequently, electronic frameworks and real frameworks are generated, fabricated and rendered and, subsequently, adapted, edited, modified, as described herein.

Said electronic frameworks appear as digital 2-D and 3-D images and videos with and without associating with relating body parts as described infra in the viewing screens and touchscreens of said computers and devices. These interactive images and videos can be marked, edited, commented, highlighted, manipulated and rotated in 3 dimensions with all said appearances and designs in said screens of said computers and devices by repositories described herein.

Said server repositories to calculate and request and accept electronic fee payments from said requesting repositories and grant permissions for said fee payments associated with said renderings and fabrications to be debited from individual patients' accounts. Said debits are credited and transferred to assigned accounts in and among banks and financial institutions. In addition, said server repositories record and tally said transactions through said networks.

Although various preferred embodiments of the present invention have been described, it will be appreciated by those skilled in the art that adaptations, variations and derivatives of said embodiments are and will be made and achieved for people and animals without departing from the spirit and scope of the specification of the present invention.

1. A system for healing disordered human soft tissues through networks, said system having server repositories for prescribing specific electronic frameworks for healing specific disordered soft tissues and for functionally and biomechanically related body parts of specific patients based on the associations of first digital data and second digital data in the storage means of said server repositories, each association of data specifying how prescribing repositories instruct networked manufacturing machines and 3-D printers how to fabricate and render diverse specific real frameworks for physically reinforcing and supporting specific disordered soft tissues of specific body parts and frameworks for functionally and biomechanically related body parts of specific patients, said system comprising:
said first digital data comprising electronically tagged or accentuated anatomical landmarks of disordered body parts and functionally and biomechanically related body parts in images and videos having attached data on medical histories and proportional anatomical dimensions of specific patients, said first digital data are inputted by networked requesting repositories to said server repositories, said second digital data on disordered soft tissues of body parts having attached data on the functional anatomy and biomechanics of individual body parts and functionally and biomechanically related body parts of people;
each of said associations wherein each second data specifying to said server repository the rendering of designs and configurations and interrelated components of each specific electronic framework or frameworks for a specific patient based on said first digital data, and wherein each first data specifying to said server repository specific components, physical characteristics and properties including dimensions and fits and visually-distinctive labels of said specific electronic framework or frameworks, said server repository instructs said networked machine and 3-D printer how to apply said specific electronic framework or frameworks to fabricate and render real framework or frameworks specific to specific disordered part and functionally and biomechanically related body parts of specific patient associating with specific request;
a plurality of networked servers, computers and mobile communication devices including smartphones having touchscreens and manufacturing machines and 3-D printers comprising a plurality of repositories, each of said repositories comprising:
a plurality of external interfaces for removably coupling to said networks;
storage means for storing and associating said first and second digital data having attached relevant electronic frameworks and derivatives;
requesting repositories for generating individual specific requests to server repositories to prescribe individual electronic frameworks based said first digital data inputted from said requesting repositories in said networks, each request indicating a rendering of at least one electronic framework specific to and fit said disordered body part and electronic frameworks specific to and fit functionally and biomechanically related body parts of a patient;
processing means for processing and storing said requests and first data in said storage means, said first data specifying how said server repositories prescribe said electronic frameworks, and how said prescribing repositories instruct said networked to manufacturing machines including 3-D printers how to fabricate and render real frameworks for specific disordered parts and functionally and biomechanically related body parts of specific patients in same location or setting or diverse locations or diverse settings;
each of said requesting repositories further removably coupled to said server repositories for processing fee payments for rendering said frameworks, said server repositories for requesting and accepting electronic fee payments from said requesting repositories and said fee payments from server repositories of banks and financial institutions, said server repositories for recording and tallying said transactions through said networks;
said server repositories for sending and sharing data on said electronic frameworks attaching to relating body parts to said networked computers and devices wherein said requesting repositories display said data as images and videos in said viewing screens and touchscreens of said computers and devices; and
computer programs for rendering said system and method attached to said processing means.

2. Said electronic frameworks stored in said storage means in claim 1 are data adaptable and editable by said repositories;

3. Said electronic frameworks in claim 1 are retrievable as digital images and videos in the viewing screens and touchscreens from said storage means by said repositories in said networks.

4. Each of said electronic frameworks stored in said storage means in claim 1 is adaptable and editable by said repositories, based on based on adaptation to said first data associating with said second data in said networks;

5. Each of said real frameworks in claim 1 is a reproduction of said electronic framework stored in said storage means.

6. The real frameworks in claim 1 comprise various compositions of tapes, fabrics, wires, adhesives and attachments and any combinations thereof.

7. The real frameworks in claim 1 comprise productions of 3-D printers networked to said server repositories.

8. The tapes, fabrics and wires in claim 1 are flexible, extendable and rigid tapes, fabrics and wires having adhesive and nonadhesive means for gluing, bonding and attaching said tapes, fabrics, wired and body parts.

9. The soft tissues in claim 1 are ligaments, muscles, tendons, connective tissues and joints.

10. The medical histories in claim 1 include, but not limited to, repetitive strain injuries, cumulative trauma disorders, overuse syndromes, chronic pain, acute, subacute and chronic traumas, injuries, degenerative diseases, diverse musculoskeletal, soft tissue and autoimmune diseases.

11. The visually-distinctive labels in claim 1 are color and digital markings generated and created in said repositories in said networks.

12. The computer programs in claim 1 are in said repositories in said networks.

13. In a system for healing disordered human soft tissues through networks, a method for prescribing specific adaptable and editable electronic frameworks for healing specific disordered of specific patients by server repositories, based on said electronic frameworks said server repositories instruct networked manufacturing machines and 3-D printers how to fabricate and render diverse specific real frameworks of tapes, fabrics and wires for physically reinforcing and supporting specific disordered soft tissues of specific body parts of patients, said method comprising the steps of:
storing data on the functional anatomy and biomechanics of said soft tissues of body parts having attached disorders and diseases;
attaching data on individual medical histories and proportional anatomical dimensions of disordered body parts and functionally and biomechanically related body parts having electronically tagged or accentuated anatomical landmarks of body parts of individual patients in images or videos to data on the functional anatomy and biomechanics of soft and bony tissues of said parts, said attached data specifying how a real framework is prescribed by the processing means for processing said data inputs and how said processing means instruct
manufacturing machines and 3-D printers how to fabricate specific real frameworks for fixing individual disordered body parts of specific patients and how individual fees associating with manufacturing processes to be paid upon individual patients accepting individual real frameworks;
storing said data in a plurality repositories of networked servers, computers and mobile communication devices including smartphones having touchscreens and manufacturing machines for fabricating said real frameworks, said server repositories for controlling requests for prescribing from said computers and devices and for controlling said manufacturing machines for fabricating or printing frameworks associating with said requests;
said server repositories receiving requests for rendering prescriptions of frameworks based on said data from requesting repositories and storing said requests including said data inputs from said networked computers and devices in the storage means;
processing means processing requests of requesting repositories and store said requests in said storage means and said server repositories prescribing specific electronic frameworks and, based on specific electronic frameworks, said server repositories instruct said networked manufacturing machines including 3-D printers in same locations or settings or diverse locations or diverse settings how to fabricate specific frameworks of tapes, fabrics and wires for specific patients associating with requesting repositories;
said requesting repositories commenting and adapting related electronic frameworks stored in said repositories having subsequent first data, said server repositories adapting, modifying and editing data on said electronic framework stored in said storage means whenever said server repositories received requests having with said subsequent first data from said requesting repositories associating with said electronic frameworks and, consequently, said server repositories instruct said networked manufacturing machine or 3-D printer how to modify and adjust relevant frameworks or fabricate or render specific new frameworks based on said first data;
said requesting and server repositories disseminating and sharing data on said electronic frameworks, said data are rendered by said repositories as interactive digital images and videos with and without relating digital body parts in said viewing screens and touchscreens;
attaching computer programs for rendering said system and method to said processing means in said repositories in said networks so that said data on said digital frameworks are reciprocally rendered, adapted and modified by requesting and server repositories in said networks;
said server repositories requesting for and accepting electronic fee payments from said requesting repositories and said fee payments from banks and financial institutions; and
said server repositories requesting for and accepting electronic fee payments from said requesting repositories and credits comprising said individual fee payments from individual patients' accounts in banks and financial institutions, said server repositories for recording and tallying said transactions through said networks.

14. In a system for rendering frameworks for reinforcing and healing disordered soft tissues of body parts of patients through networks by a rendering system, said system comprised prescribing repositories networked to rendering framework-fabricating machines and 3-D printers, said prescribing repositories utilizing first digital rendering data inputted by requesting repositories associating with second data to prescribe specific electronic frameworks for specific patients and, based on said specific electronic frameworks, said prescribing repositories instruct said machines and printers how to fabricate and render specific real frameworks for specific disordered soft tissues and functionally and biomechanically related body parts, said method comprising the steps of:
networking a plurality of servers, computers and mobile communication devices including smartphones having touchscreens and said machines and printers comprising said repositories, said repositories comprising the steps of:
storing a second data on functional anatomy and biomechanics of body parts having attached data on the derangements of soft and bony tissues and biomechanics of said body parts caused by local and systemic disorders and diseases in server repositories, said second data specifying the configurations, designs and physical properties of individual frameworks and the types of fee payments to be made by the requesting repositories;
said requesting repositories sending said first data requesting said frameworks to said server repositories wherein said server repositories accept and store said first data comprising digital electronically tagged or accentuated anatomical landmarks of body parts of patients in images and videos having attached data on proportional anatomical dimensions of body parts;
processing means processing requests of said requesting repositories in said storage means by associating said first data with said second data, said second data specifying how said prescribing repositories prescribe specific electronic frameworks based on specific association of said first and second data;
said server repositories prescribing specific electronic frameworks associating with specific disordered soft tissues of specific patients and, based on said specific electronic frameworks, said prescribing repositories instruct said networked manufacturing machines including 3-D printers in same locations or settings or diverse locations or diverse settings how to fabricate specific real frameworks of tapes, fabrics and wires for said specific patients associating with requesting repositories;
said requesting repository sending requests for adaptations and modifications of related electronic framework stored in said requesting repository having subsequent first data, said server repositories adapting, modifying and editing said electronic framework stored in said storage means whenever said server repositories received request having with said subsequent first data from said requesting repository associating with said electronic framework and, consequently, said server repository instruct said networked manufacturing machines and 3-D printers how to modify and adjust relevant frameworks or fabricate or render new frameworks based on said first data;
said prescribing repositories instructing said rendering framework-fabricating machines and 3-D printers how to fabricate and render specific real frameworks for specific disordered soft tissues of specific patients having proportional anatomical dimensions of body parts;
said requesting and server repositories disseminating and sharing data on said electronic frameworks, said data are rendered by said repositories as interactive digital images and videos with and without relating digital body parts in said viewing screens and touchscreens;
attaching computer programs for rendering said system and method to said processing means in said repositories in said networks so that said data on said digital frameworks are reciprocally rendered, adapted and modified by requesting and server repositories in said networks; and
said server repositories to request and accept electronic fee payments from said requesting repositories and to grant permissions for said fee payments associated with said renderings and fabrications to be debited from individual patients' accounts to be credited to assigned accounts in and among banks and financial institutions, said server repositories for recording and tallying said transactions through said networks.
